(19) United States
(12) Patent Application Publication
(10) Pub. No.: US 2024/0089046 A1
(43) Pub. Date: Mar. 14, 2024

(54) MANAGEMENT OF POSITION REFERENCE SIGNALS AND MEASUREMENT GAPS

(71) Applicant: QUALCOMM Incorporated, San Diego, CA (US)

(72) Inventors: Manzil SARAF, Hyderabad (IN); Mukesh KUMAR, Hyderabad (IN); Praveen KONA, Hyderabad (IN); Mahendar Reddy THANGELLA, Hyderabad (IN); Raevanth Venkat ANNAM, Hyderabad (IN); Sivasubramanian RAMALINGAM, Hyderabad (IN); Rajubhai Dileepbhai DHEDHI, Hyderabad (IN)

(21) Appl. No.: 17/930,984

(22) Filed: Sep. 9, 2022

(51) Int. Cl. H04L 5/00; H04W 24/10; H04W 72/12

(52) U.S. Cl. CPC H04L 5/0048; H04W 24/10; H04W 72/1205

(57) ABSTRACT

A user equipment (UE) may obtain a first indication of a first measurement gap resource associated with a first time period. The UE may receive a set of position reference signals (PRSs) during a PRS occasion. A first portion of the PRS occasion may not overlap with any portion of the first time period. The UE may measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.

### TECHNICAL FIELD

The present disclosure relates generally to communication systems, and more particularly, to a user equipment (UE) that manages position reference signals (PRSs) and measurement gaps (MGs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may obtain a first indication of a first measurement gap resource associated with a first time period. The apparatus may receive a set of position reference signals (PRSs) during a PRS occasion. A first portion of the PRS occasion may not overlap with any portion of the first time period. The apparatus may measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram of positioning reference signal (PRS) scheduling, in accordance with various aspects of the present disclosure.

FIG. 6 is a diagram of PRS and measurement gap scheduling, in accordance with various aspects of the present disclosure.

FIG. 7 is a diagram of a revised PRS and measurement gap scheduling, in accordance with various aspects of the present disclosure.

FIG. 8 is a diagram of another PRS and measurement gap scheduling, in accordance with various aspects of the present disclosure.

FIG. 9 is a diagram of a revised PRS and measurement gap scheduling, and for a measurement gap occasion, in accordance with various aspects of the present disclosure.

FIG. 10 is a diagram of PRS, SSB, and measurement gap scheduling, in accordance with various aspects of the present disclosure.

FIG. 11 is a diagram of a revised PRS, SSB, and measurement gap scheduling, in accordance with various aspects of the present disclosure.

FIG. 12 is a diagram of another revised PRS, SSB, and measurement gap scheduling, in accordance with various aspects of the present disclosure.

FIG. 13 is a diagram of another revised PRS, SSB, and measurement gap scheduling, in accordance with various aspects of the present disclosure.

FIG. 14 is a flowchart of a method of wireless communication.

FIG. 15 is another flowchart of a method of wireless communication.

FIG. 16 is a diagram illustrating an example of a hardware implementation for an example apparatus and/or network entity.

### DETAILED DESCRIPTION

A user equipment (UE) may be scheduled to perform positioning reference signal (PRS) measurements and other measurements that may conflict with performing the PRS measurements. In one aspect, a time period when a UE may be scheduled to measure a set of PRSs (i.e., a PRS occasion) may collide with a time period when the UE may be scheduled to measure a signal using a measurement gap resource (i.e., a measurement gap occasion). In another aspect, a measurement gap occasion may allow a signal, such as a synchronization signal block (SSB) to be measured during the measurement gap occasion, but may not allow a PRS to also be measured during the same measurement gap occasion. A UE having a PRS scheduling that conflicts with measurement gap scheduling may be configured to opportunistically resolve such conflicts by measuring a set of PRSs during non-colliding time periods, transmitting a request for a positioning processing window (PPW) for measuring the set of PRSs, or allocating a new measurement gap resource for measuring the set of PRSs.

In one aspect, a UE may obtain a first indication of a first measurement gap resource associated with a first time period. The UE may receive a set of PRSs during a PRS occasion. A first portion of the PRS occasion may not overlap with any portion of the first time period. The UE may measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media may include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

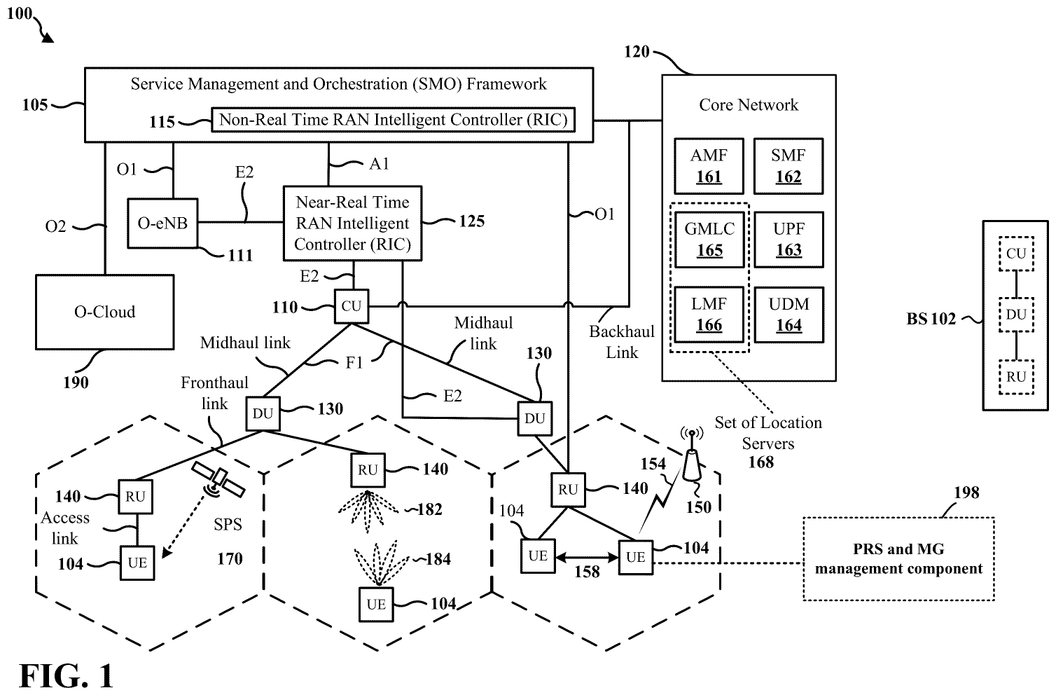

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a PRS and measurement gap (MG) management component 198 configured to obtain a first indication of a first measurement gap resource associated with a first time period. The PRS and MG management component 198 may be configured to receive a set PRSs during a PRS occasion. A first portion of the PRS occasion may not overlap with any portion of the first time period. The PRS and MG management component 198 may be configured to measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion. Although the following description may be focused on managing PRS and MG resources, the concepts described herein may be applicable to other areas for managing disparate scheduled wireless signals, such as wireless signals from serving cells and non-serving cells or wireless signals from terrestrial network nodes and non-terrestrial network nodes.

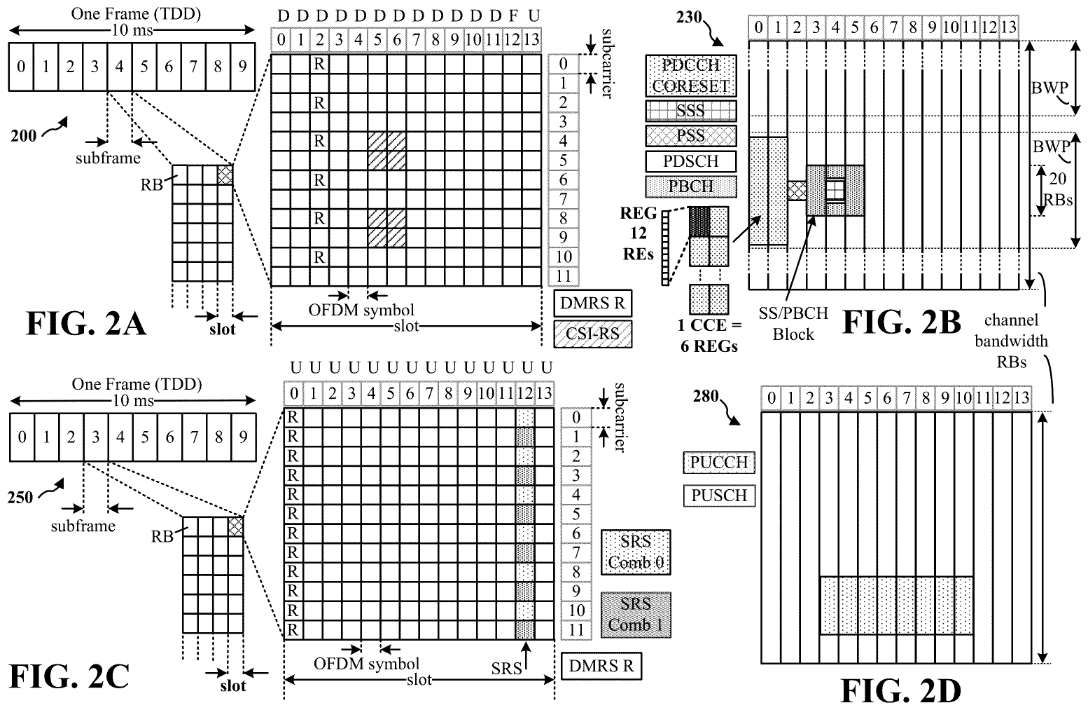

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

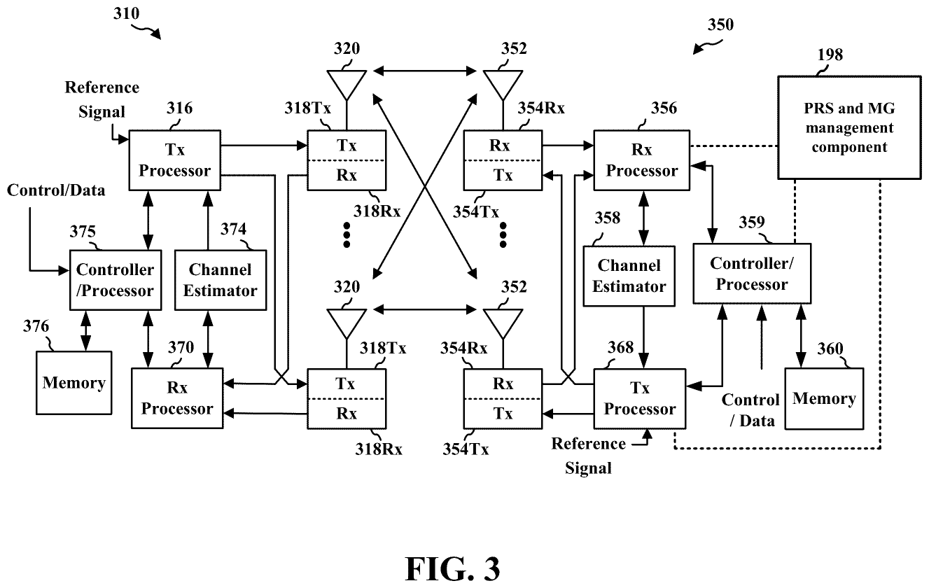

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (Tx) processor 316 and the receive (Rx) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The Tx processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (Rx) processor 356. The Tx processor 368 and the Rx processor 356 implement layer 1 functionality associated with various signal processing functions. The Rx processor 356 may perform spatial processing on the information to recover any spatial streams destined for the UE 350. If multiple spatial streams are destined for the UE 350, they may be combined by the Rx processor 356 into a single OFDM symbol stream. The Rx processor 356 then converts the OFDM symbol stream from the time-domain to the frequency domain using a Fast Fourier Transform (FFT). The frequency domain signal may include a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the Tx processor 368 to select the appropriate coding and modulation schemes, and to facilitate spatial processing. The spatial streams generated by the Tx processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a Rx processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the Tx processor 368, the Rx processor 356, and the controller/processor 359 may be configured to perform aspects in connection with the PRS and MG management component 198 of FIG. 1.

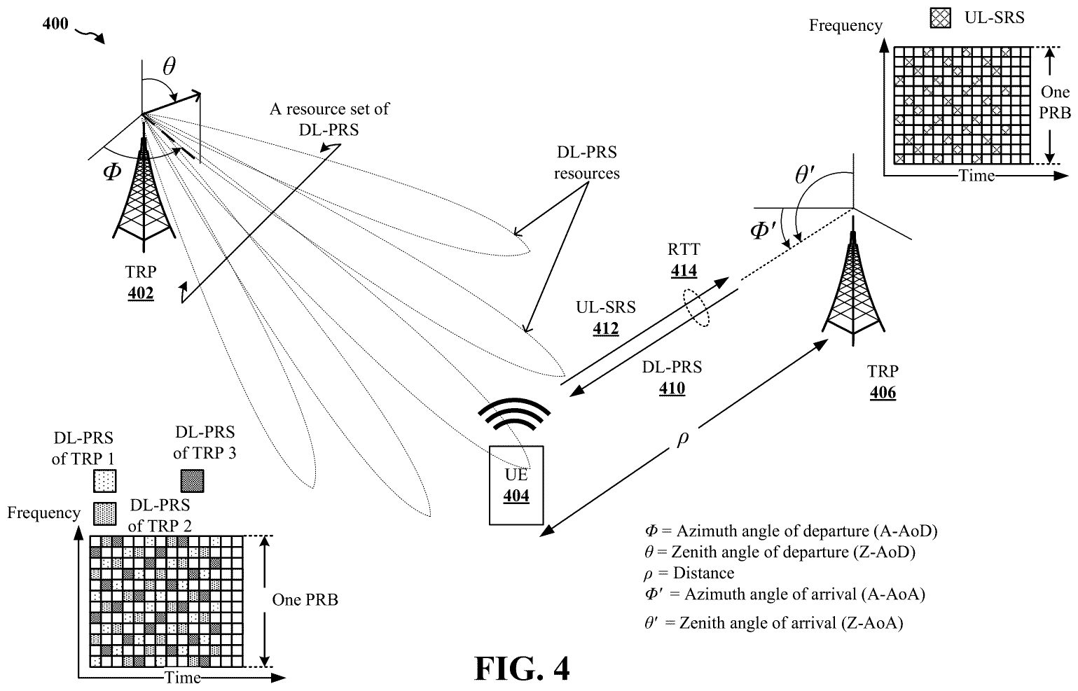

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS}_RX and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

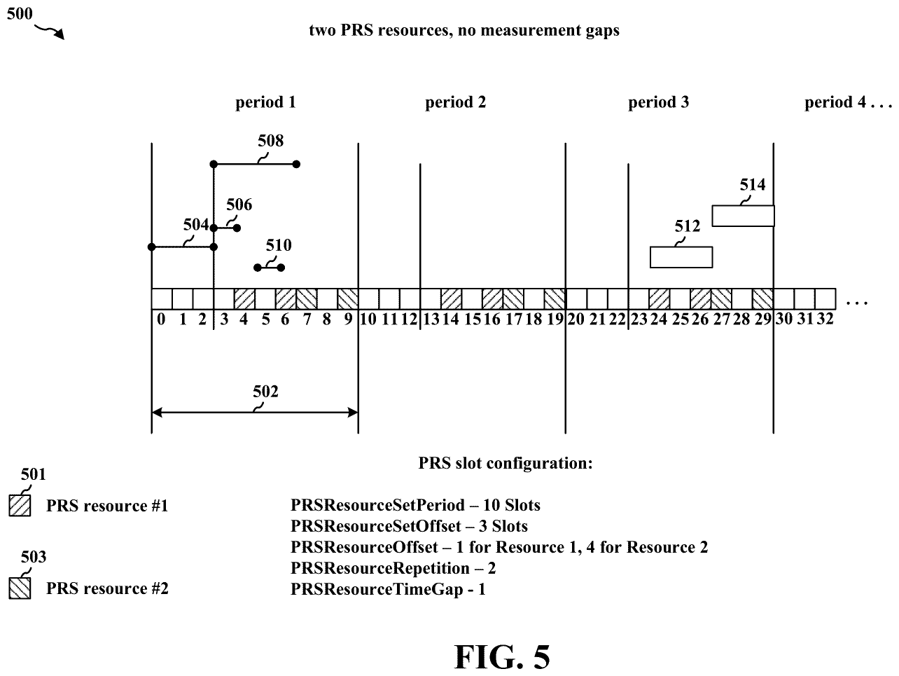

FIG. 5 is a diagram 500 of PRS scheduling, in accordance with various aspects of the present disclosure. The diagram 500 of PRS scheduling may be for a set of DL-PRS scheduled for a UE, such as the UE 104 in FIG. 1 or the UE 404 in FIG. 4. The UE may be scheduled to receive a first set of PRSs 501 (i.e., PRS resource #1) from a first network node and may be scheduled to receive a second set of PRSs 503 (i.e., PRS resource #2) from a second network node.

The first set of PRSs 501 may be configured to be received in accordance with a PRS resource set period or a PRS resource set instance. The first set of PRSs 501 may have a PRS resource set period 502 of 10 slots. In other words, the first set of PRSs 501 may be scheduled to be received every 10 slots. The first set of PRSs 501 may have a PRS resource set offset 504 of 3 slots. In other words, the first set of PRSs 501 may be offset from a start of a period by 3 slots. The first set of PRSs 501 may have a PRS resource repetition value of two. In other words, the first set of PRSs 501 may have two PRSs, a first PRS and a second PRS. The first set of PRSs 501 may have a PRS resource time gap 510 of one. In other words, each retransmitted PRS of the first set of PRSs 501 may be retransmitted after one slot from the previous transmission or retransmission. The first set of PRSs 501 may have a PRS resource offset 506 of one. In other words, the first set of PRSs 501 may be transmitted one slot after the PRS resource set offset 504. The first set of PRSs 501 may be received by the UE within a PRS occasion 512 in period 3.

The second set of PRSs 503 may be configured to be received in accordance with a PRS resource set period or a PRS resource set instance. The second set of PRSs 503 may have a PRS resource set period 502 of 10 slots. In other words, the second set of PRSs 503 may be scheduled to be received every 10 slots. The second set of PRSs 503 may have a PRS resource set offset 504 of 3 slots. In other words, the second set of PRSs 503 may be offset from a start of a period by 3 slots. The second set of PRSs 503 may have a PRS resource repetition value of two. In other words, the second set of PRSs 503 may have two PRSs, a first PRS and a second PRS. The second set of PRSs 503 may have a PRS resource time gap 510 of one. In other words, each retransmitted PRS of the second set of PRSs 503 may be retransmitted after one slot from the previous transmission or retransmission. The second set of PRSs 503 may have a PRS resource offset 508 of 4. In other words, the second set of PRSs 503 may be transmitted 4 slots after the PRS resource set offset 504. The second set of PRSs 503 may be received by the UE within a PRS occasion 514 in period 3.

The PRS scheduling shown in FIG. 5 may be based on a reference signal transmitted by the UE, for example one or more SRS transmitted by the UE. The PRS occasion 512 may not collide with the PRS occasion 514, as each occasion is in different slots of its respective period.

In some aspects a UE may be configured to perform an intra-frequency PRS measurement when an inter-frequency NR measurement or an inter-frequency LTE measurement is configured. The inter-frequency NR measurement or the inter-frequency LTE measurement may be scheduled to be measured during a measurement gap period or a measurement gap occasion. Such measurements may be, for example, an SSB measurement. Such intra-frequency PRS measurements may collide with the inter-frequency NR or LTE measurements during the measurement gap occasion. When a collision occurs, the UE may be configured to prioritize either measuring the intra-frequency PRS, or measuring an inter-frequency measurement during the measurement gap. As a result, if a PRS occasion collides with a measurement gap occasion, the PRS may be given higher priority, resulting in a lost measurement gap occasion, or the measurement gap may be given higher priority, resulting in a PRS measurement not taking place. A PRS occasion may be a period of time within which the UE is configured to measure the PRS, and a measurement gap occasion may be a period of time within which the UE is configured to measure a measurement gap signal, such as an SSB. Such occasions may be scheduled by a base station, and modified by the UE.

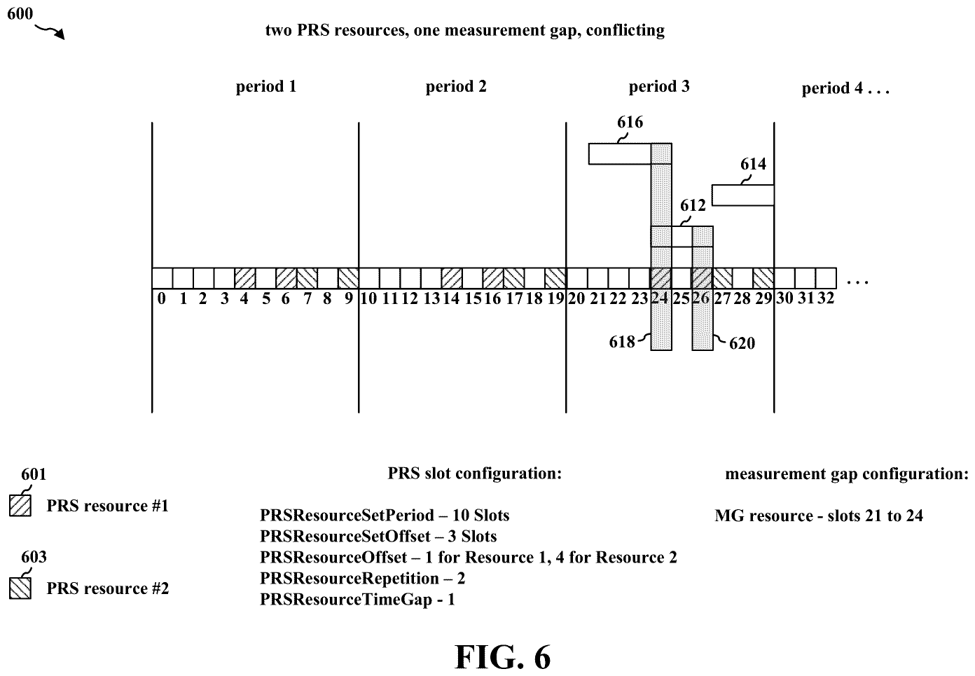

FIG. 6 is a diagram 600 of PRS and measurement gap scheduling, in accordance with various aspects of the present disclosure. The diagram 600 of PRS scheduling may be for a set of DL-PRS scheduled for a UE, such as the UE 104 in FIG. 1 or the UE 404 in FIG. 4. The UE may be scheduled to receive a first set of PRSs 601 (i.e., PRS resource #1) from a first network node and may be scheduled to receive a second set of PRSs 603 (i.e., PRS resource #2) from a second network node, similar to the first set of PRSs 501 and the second set of PRSs 503 in FIG. 5. The first set of PRSs 601 may be received by the UE within a PRS occasion 612 in period 3. The second set of PRSs 603 may be received by the UE within a PRS occasion 614 in period 3.

The UE may be configured to perform an inter-frequency NR measurement during a measurement gap occasion 616 located at slots 21 to 24. However, the measurement gap occasion 616 may collide with the PRS occasion 612 associated with the first set of PRSs 601 at slot 24, shown as colliding slots 618. The PRS occasion 612 associated with the first set of PRSs 601 may not collide with the measurement gap occasion 616 at slot 26, shown as non-colliding slots 620. If the UE is configured to give priority to PRS, the UE may measure the first set of PRSs 501 at slot 24 within the measurement gap occasion 616. For example, the UE may make a PRS RSTD measurement at slot 24 during the PRS occasion 612. As a result, the UE may not make inter-frequency measurements during the measurement gap occasion 616. If the UE is configured to give priority to the measurement gap, the UE may perform an inter-frequency NR measurement during the measurement gap occasion 616. For example, the UE may make measure and/or decode an inter-frequency SSB transmitted at slot 24 during the measurement gap occasion 616. As a result, the UE may not make PRS RSTD measurements during the PRS occasion 612.

The diagram 600 illustrates an example of a PRS occasion 612 colliding with a measurement gap occasion 616 having a measurement gap length of 4 slots. In NR cells configured with a measurement gap length of 6 slots or more, the probability of collisions with an intra-frequency PRS occasion may be higher.

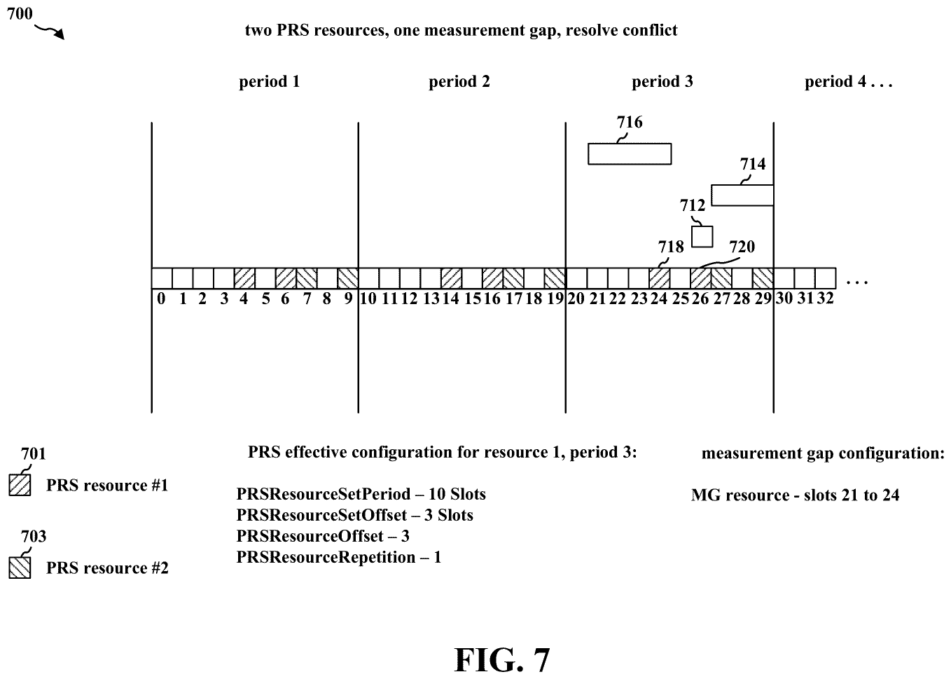

In some aspects, a UE may be configured to utilize both PRS measurements and gap measurements for optimal functionality when a PRS occasion and a measurement cap occasion collide with one another, such as an intra-frequency PRS and an inter-frequency gap measurement. FIG. 7 is a diagram 700 of a revised PRS and measurement gap scheduling, in accordance with various aspects of the present disclosure. The diagram 700 of PRS scheduling may be for a set of DL-PRS scheduled for a UE, such as the UE 104 in FIG. 1 or the UE 404 in FIG. 4. The UE may be scheduled to receive a first set of PRSs 701 (i.e., PRS resource #1) from a first network node and may be scheduled to receive a second set of PRSs 703 (i.e., PRS resource #2) from a second network node, similar to the first set of PRSs 601 and the second set of PRSs 603 in FIG. 6.

In FIG. 6, the PRS occasion 612 collided with the measurement gap occasion 616 at slot 24. Even though slot 26 of the PRS occasion 612 does not collide with the measurement gap occasion 616, the UE may consider the measurement gap occasion 616 to collide with all of the PRS occasion 612—even slot 26—because the PRS occasion 612 collides with the measurement gap occasion 61 at slot 24. In order to avoid this collision, the UE of diagram 700 may be configured to use the colliding slots 618 for gap measurements and the non-colliding slots 620 for PRS measurements, such as RSTD measurements. Since the colliding slots 618 and the non-colliding slots 620 have the same retransmitted PRS of the set of PRSs 601, so long as the UE measures one of the two retransmitted PRSs of the set of PRSs 601, the UE may perform a PRS measurement.

Specifically, in FIG. 7, the UE may perform a measurement gap measurement, such as an inter-frequency NR measurement, during the measurement gap occasion 716, and may perform a PRS measurement, such as measuring an RSTD of a PRS of the first set of PRSs 701, during the effective PRS occasion 712. In other words, the UE may not measure the PRS 718 of the first set of PRSs 701, but may measure the PRS 720 of the first set of PRSs 701 during the effective PRS occasion 712. The UE may skip measuring one or more of a set of PRSs so long as the PRS resource repetition value associated with the set of PRSs is greater than one, which means that at least one PRS is retransmitted. The UE may measure the second set of PRSs 703 during the PRS occasion 714. This solution may provide an efficient way to detect a collision and manage PRS resources effectively so that both measurement gap measurements and RSTD measurements may occur in tandem.

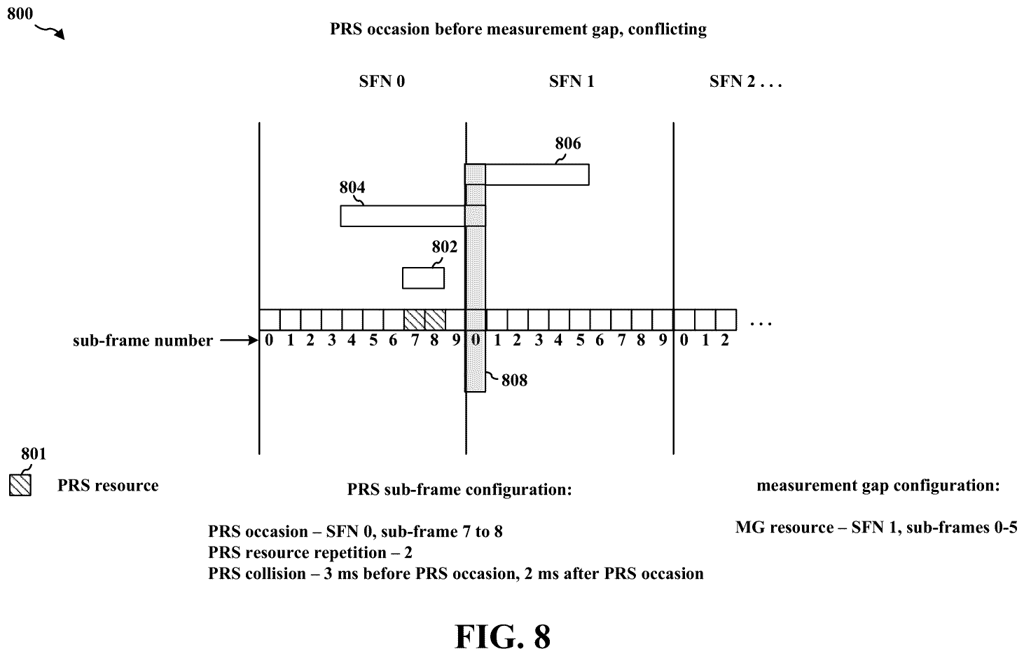

FIG. 8 is a diagram 800 of another PRS and measurement gap scheduling, in accordance with various aspects of the present disclosure. The diagram 800 of PRS scheduling may be for a set of DL-PRS scheduled for a UE, such as the UE 104 in FIG. 1 or the UE 404 in FIG. 4. The UE may be scheduled to receive a set of PRSs 801 from a network node. The set of PRSs 801 may be configured to be received in accordance with a PRS resource set period or a PRS resource set instance. The set of PRSs may have a PRS resource repetition value of two. In other words, the set of PRSs 801 may have two PRSs, a first PRS and a second PRS. The set of PRSs 501 may have a PRS occasion at system frame number (SFN) 0 at sub-frames 7 and 8. In other words, one of the set of PRSs 801 may be at SFN 0, sub-frame 7, and another of the set of PRSs 801 may be at SFN 0, sub-frame 8. The set of PRSs 801 may have a PRS resource time gap of zero. In other words, each retransmitted PRS of the set of PRSs 801 may be retransmitted immediately after the sub-frame from the previous transmission or re-transmission. The set of PRSs 801 may have a collision range 804 defined as three milliseconds (ms) before the PRS occasion 802 and two ms after the PRS occasion 802. In other words, the collision range 804 of the set of PRSs 801 may span from SFN 0, sub-frame 4 to SFN 1, sub-frame 0.

The UE may be configured to perform an inter-frequency LTE measurement during a measurement gap occasion 806 located at SFN 1, sub-frame 0 to SFN 1, sub-frame 5. However, the measurement gap occasion 806 may collide with the collision range 804 of the set of PRSs 801 (or the PRS occasion 802) associated with the first set of PRSs 801 at SFN 1, sub-frame 0, shown as colliding sub-frames 808. If the UE is configured to give priority to PRS, the UE may measure the set of PRSs 801 during the PRS occasion 802. For example, the UE may make a PRS RSTD measurement at SFN 0, sub-frames 7 and 8 during the PRS occasion 802. As a result, the UE may not make inter-frequency measurements during the measurement gap occasion 806, as the measurement gap occasion 806 may collide with the collision range 804 of the set of PRSs 801. If the UE is configured to give priority to the measurement gap, the UE may perform an inter-frequency LTE measurement during the measurement gap occasion 806. For example, the UE may make measure and/or decode an inter-frequency SSB transmitted at SFN 1, sub-frame 0 during the measurement gap occasion 806. As a result, the UE may not make PRS RSTD measurements during the PRS occasion 802.

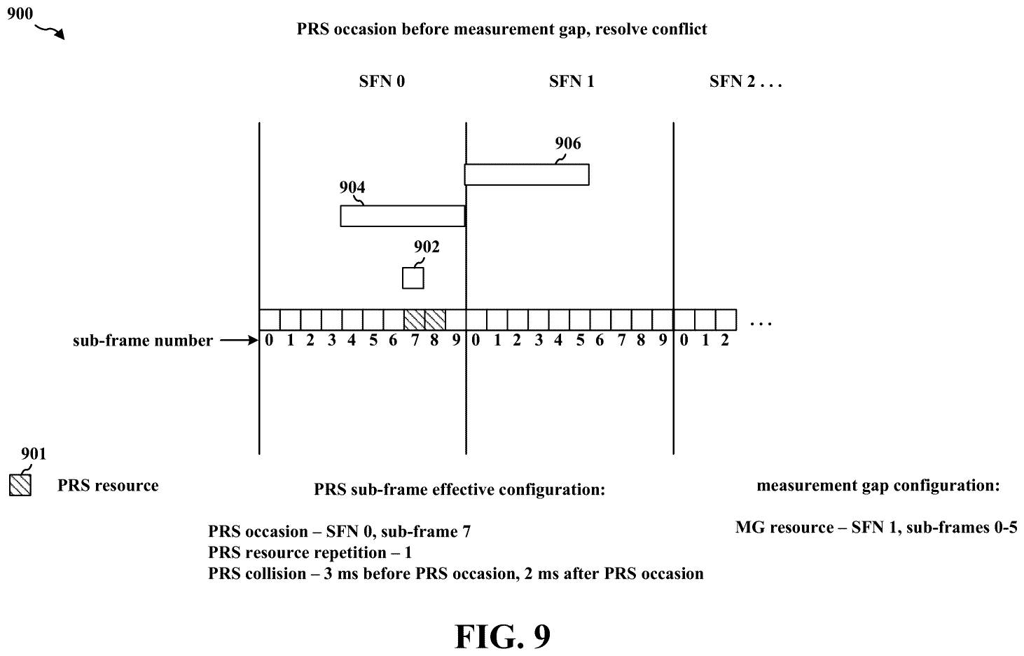

The PRS occasion 802 associated with the set of PRSs 801 may not collide with the measurement gap occasion 806 if the UE does not measure the set of PRSs 801 at SFN 1, sub-frame 8. FIG. 9 is a diagram 900 of a revised PRS and measurement gap scheduling, in accordance with various aspects of the present disclosure. FIG. 9 is a diagram 900 of a revised PRS and measurement gap scheduling, in accordance with various aspects of the present disclosure. The diagram 900 of PRS scheduling may be for a set of DL-PRS scheduled for a UE, such as the UE 104 in FIG. 1 or the UE 404 in FIG. 4. The UE may be scheduled to receive a set of PRSs 901 from a network node, similar to the set of PRSs 801 in FIG. 8.

In FIG. 8, the PRS occasion 802 collided with the measurement gap occasion 806 at colliding sub-frames 808. In order to avoid this collision, the UE of diagram 900 may be configured to measure the set of PRSs 801 during the effective PRS occasion 902 at SFN 0, sub-frame 7, and not during SFN 0, sub-frame 8. Since the PRS at SFN 0, sub-frame 7 and the PRS at SFN 0, sub-frame 8 have the same retransmitted PRS of the set of PRSs 901, so long as the UE measures one of the two retransmitted PRSs of the set of PRSs 801, the UE may perform a PRS measurement.

Specifically, in FIG. 9, the UE may perform a PRS measurement, such as measuring an RSTD of a PRS of the set of PRSs 901, during the effective PRS occasion 902, and may perform a measurement gap measurement, such as an inter-frequency LTE measurement, during the measurement gap occasion 906. In other words, the UE may not measure the set of PRSs at SFN 0, sub-frame 8 and may measure the set of PRSs at SFN 0, sub-frame 7. As a result, the collision range 904 may not collide with the measurement gap occasion 906. The UE may skip measuring one or more of a set of PRSs so long as the PRS resource repetition value associated with the set of PRSs is greater than one, which means that at least one PRS is retransmitted. This solution may provide an efficient way to detect a collision and manage PRS resources effectively so that both measurement gap measurements and RSTD measurements may occur in tandem.

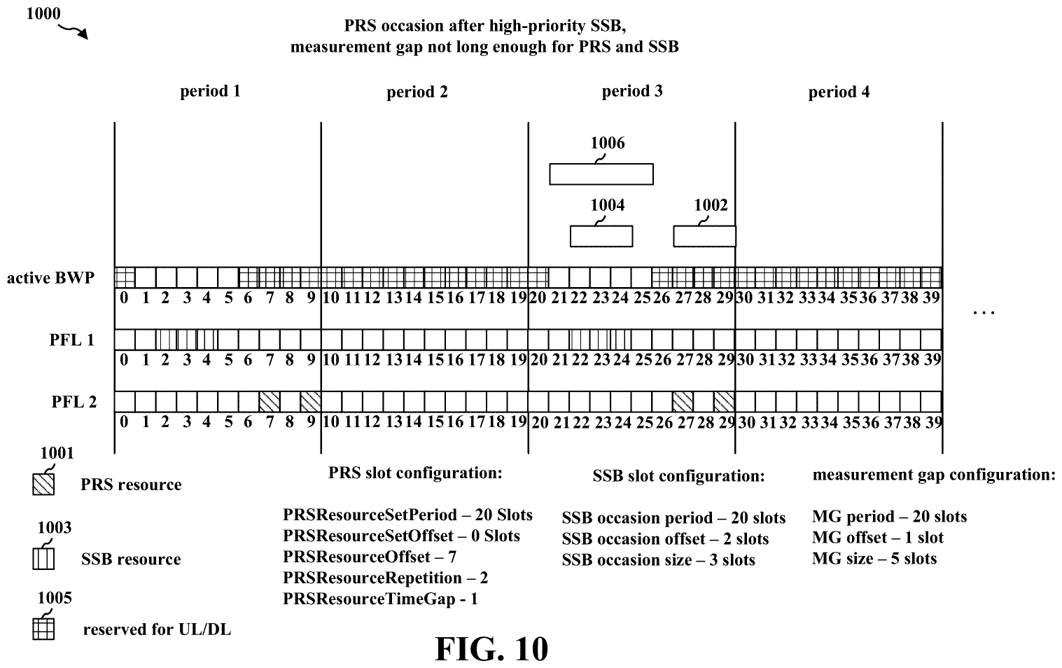

FIG. 10 is a diagram 1000 of a measurement gap occasion 1006 scheduled to allow a UE to measure a set of SSB 1003, however the measurement gap occasion 1006 may not allow the UE to measure a set of PRSs 1001 that do not overlap with the measurement gap occasion 1006, in accordance with various aspects of the present disclosure. The measurement gap occasion 1006 may be scheduled for a time that is not reserved for UL/DL transmissions 1005 with the UE.

The set of PRSs 1001 may be configured to be received in accordance with a PRS resource set period or a PRS resource set instance. The set of PRSs 1001 may have a PRS resource set period of 20 slots. In other words, the set of PRSs 1001 may be scheduled to be received every 20 slots. The set of PRSs 1001 may have a PRS resource set offset of 0 slots. In other words, the set of PRSs 1001 may be offset from a start of a period by 0 slots. The set of PRSs 1001 may have a PRS resource repetition value of two. In other words, the set of PRSs 1001 may have two PRSs, a first PRS and a second PRS. The set of PRSs 1001 may have a PRS resource time gap of one. In other words, each retransmitted PRS of the set of PRSs 1001 may be retransmitted after one slot from the previous transmission or retransmission. The set of PRSs 1001 may have a PRS resource offset of seven. In other words, the set of PRSs 1001 may be transmitted seven slot after the PRS resource set offset. The set of PRSs 1001 may be received by the UE within a PRS occasion 1002 in period 3.

The set of SSB 1003 may be configured to be received in accordance with an SSB occasion set period or an SSB occasion set instance. The set of SSB 1003 may have an SSB occasion period of 20 slots. In other words, the set of SSB 1003 may be scheduled to be received every 20 slots. The set of SSB 1003 may have an SSB occasion set offset of 2 slots. In other words, the set of SSB 1003 may be offset from a start of a period by 2 slots. The set of SSB 1003 may be of a size of three slots. The set of SSB 1003 may be received by the UE within an SSB occasion 1004 in period 3.

The measurement gap occasion 1006 may be configured to be scheduled during a time period that is not reserved for an UL/DL transmissions 1005 with the UE. The measurement gap occasion 1006 may have a measurement gap period of 20 slots. In other words, the measurement gap occasion 1006 may be scheduled to be every 20 slots. The measurement gap occasion 1006 may have a measurement gap offset of one slot. In other words, the measurement gap occasion 1006 may be offset from a start of a period by one slot. The measurement gap occasion 1006 may be of a size of five slots. The set of five slots may be the largest possible measurement gap occasion, which prevents the measurement gap occasion 1006 having five slots to cover both the SSB occasion of three slots and the PRS occasion of three slots.

The SSB occasion 1004 may be scheduled by a serving cell or a neighbor cell of the UE. The measurement gap occasion 1006 may be configured to allow the UE to measure the set of SSB 1003 during the SSB occasion 1004, but may not be large enough to allow the UE to measure the set of SSB 1003 and the set of PRSs 1001 during the measurement gap occasion 1006. In some aspects, the UE may not be able to perform a positioning session, since there is not a gap configuration available for positioning. The positioning frequency layer (PFL) of the set of PRSs 1001 may not be the same as the active BWP of the UE. The UE may be in bad network conditions with handover events already started, preventing the UE from skipping measuring the SSB, as decoding the SSB may be of a critical priority to the UE. While the UE may transmit a request to its serving cell to change the measurement gap occasion 1006 to overlap with the set of PRSs 1001 instead of the set of SSB 1003, the serving cell may reject this request, as there may be a chance of a handover failure if the UE does not measure the set of SSB 1003. The serving cell may not be able to allocate a measurement gap large enough to accommodate both the SSB occasion 1004 and the PRS occasion 1002. In some aspects, the UE may abort the positioning session, if the UE is unable to accommodate both the SSB occasion 1004 and the PRS occasion 1002.

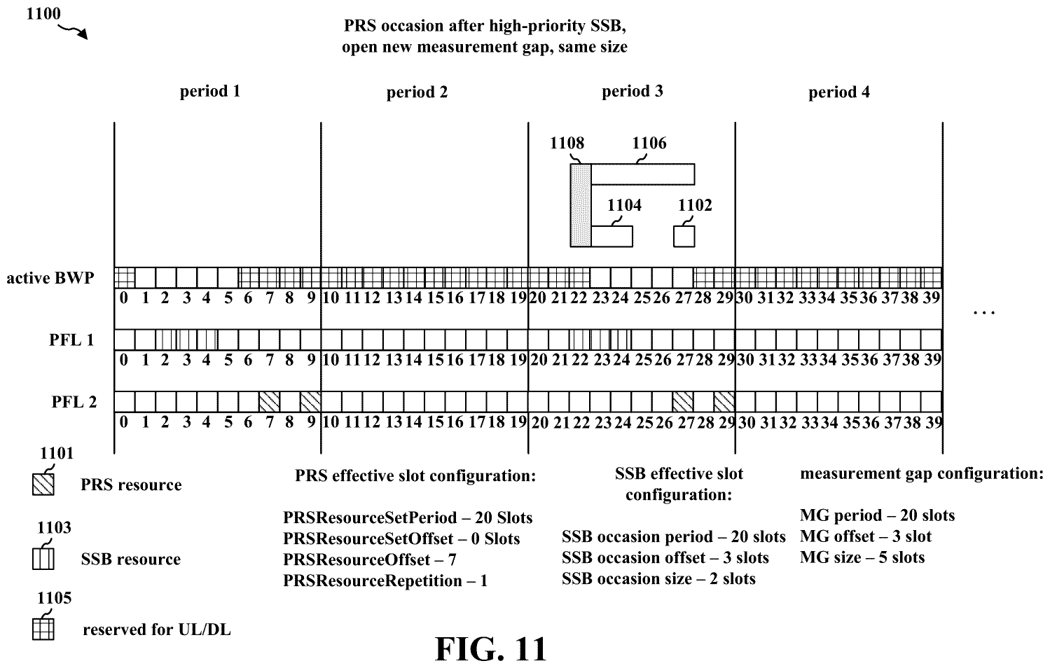

FIG. 11 is a diagram 1100 of a measurement gap occasion 1106 that has been opened by the UE to allow a UE to measure part of a set of SSB 1103 and one of a set of PRSs 1101, in accordance with various aspects of the present disclosure. The set of PRSs 1101 may be equivalent to the set of PRSs 1001 in FIG. 10, and the set of SSB 1103 may be equivalent to the set of SSB 1003 in FIG. 10. However, the set of slots reserved for the UL/DL transmissions 1105 may not allow UL/DL transmissions during slots 26 and 27 of period 3, to allow for the measurement gap occasion 1106 to overlap with the first of the set of PRSs 1101 at slot 27. Instead, the set of slots reserved for the UL/DL transmissions 1105 may allow for UL/DL transmissions during slots 21 and 22 of period 3.

The measurement gap occasion 1106 may remain 5 slots large, allowing for the UE to measure the first of the set of PRSs 1101 at slot 27 during the effective PRS occasion 1102 and a portion of the set of SSB 1103, specifically the set of SSB 1103 at slots 23 and 24 during the SSB occasion 1104. However, the colliding slots 1108 collide with the reserved slots for UL/DL transmission 1105, which prevents the measurement gap occasion 1106 from allowing all of the set of SSB 1103 from being measured by the UE. The UE may be configured to open the measurement gap occasion 1106 if both the SSB measurement and the positioning measurement are critical for the UE, for example if both have a priority higher than a threshold (e.g., a handover and a 911-initiated positioning measurement occur at the same time). The UE may optimize its process to allow decoding of at least one PRS signal along with as much of the SSB that the UE may be able to measure/decode. The UE may be configured to minimize losses of SSB signals, opportunistically opening its own measurement gap if data scheduling is not heavy (i.e., is less than or equal to a threshold value).

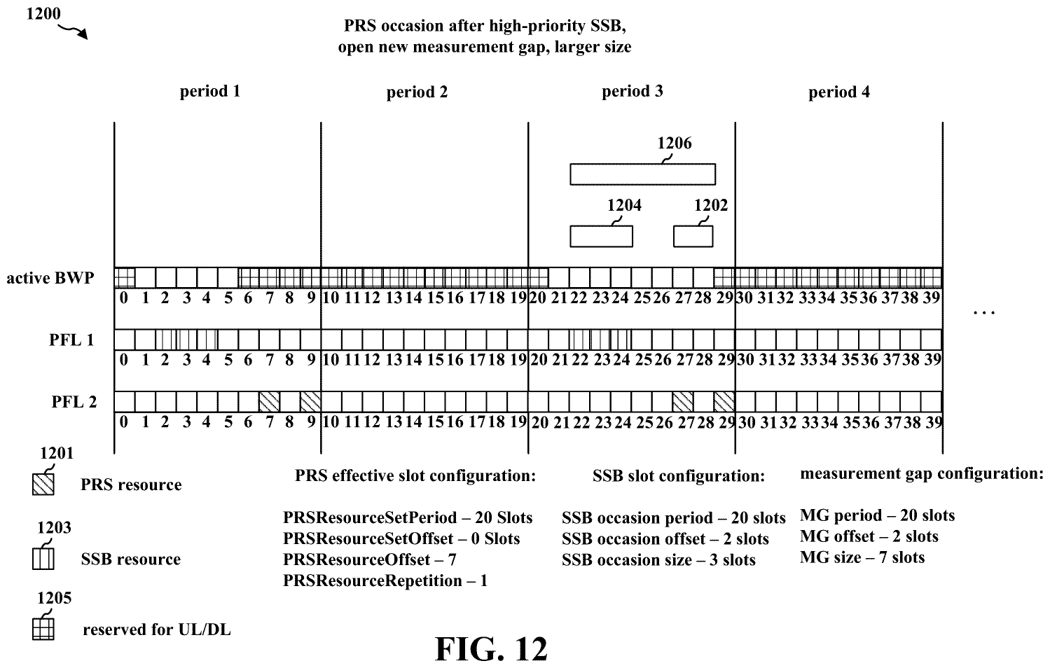

FIG. 12 is a diagram 1200 of a measurement gap occasion 1206 that has been opened by the UE to allow a UE to measure the set of SSB 1203 and the set of PRSs 1201, in accordance with various aspects of the present disclosure. The set of PRSs 1201 may be equivalent to the set of PRSs 1001 in FIG. 10, and the set of SSB 1203 may be equivalent to the set of SSB 1003 in FIG. 10. However, the set of slots reserved for the UL/DL transmissions 1205 may not allow UL/DL transmissions during slots 26, 27, and 28 of period 3, to allow for the measurement gap occasion 1206 to overlap with the set of PRSs 1201 at slots 27 and 28.

The measurement gap occasion 1206 may be larger than the measurement gap occasion 1006 in FIG. 10, allowing for the UE to measure the first of the set of PRSs 1201 at slot 27 during the effective PRS occasion 1202 and the entirety of the set of SSB 1203 during the SSB occasion 1204. The UE may be configured to open the measurement gap occasion 1206 if both the SSB measurement and the positioning measurement are critical for the UE, for example if both have a priority higher than a threshold (e.g., a handover and a 911-initiated positioning measurement occur at the same time). The UE may optimize its process to allow decoding of at least one PRS signal along with as much of the SSB that the UE may be able to measure/decode. The UE may be configured to minimize losses of SSB signals, opportunistically opening its own measurement gap if data scheduling is not heavy (i.e., is less than or equal to a threshold value), by measuring the entirety of the set of SSB 1203 while still allowing the UE to measure at least one of the set of PRSs 1201.

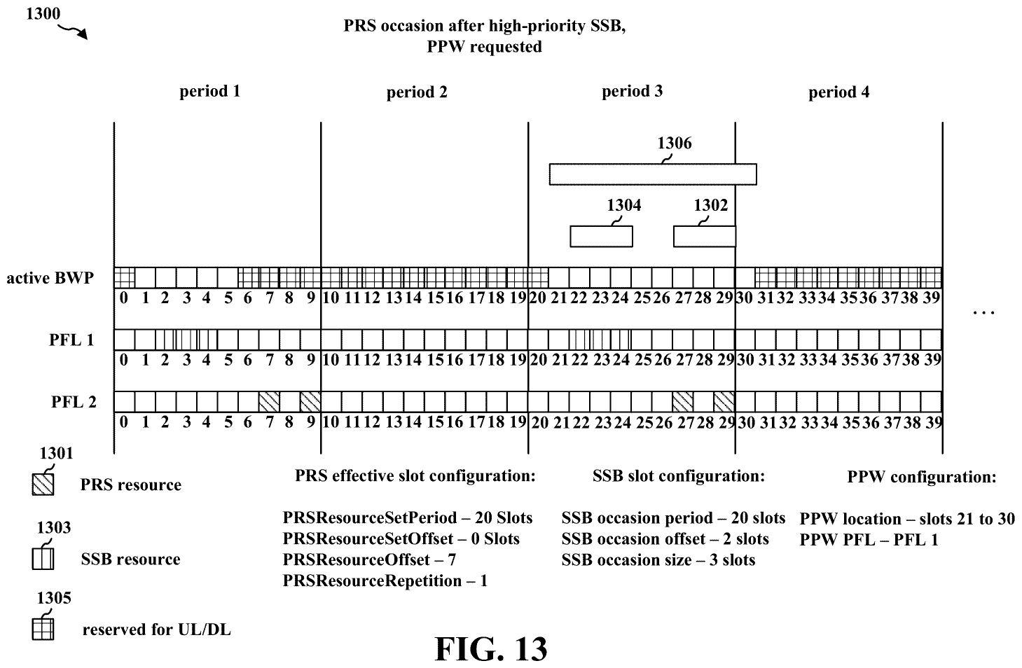

FIG. 13 is a diagram 1300 of a PPW occasion 1306 that has been requested by the UE to allow a UE to measure the set of SSB 1303 and the set of PRSs 1301, in accordance with various aspects of the present disclosure. The set of PRSs 1301 may be equivalent to the set of PRSs 1001 in FIG. 10, the set of SSB 1303 may be equivalent to the set of SSB 1003 in FIG. 10, and the set of UL/DL transmissions 1305 may be equivalent to the set of UL/DL transmissions 1305 in FIG. 10. The UE may ignore the measurement gap scheduled by the network in order to measure signals during the PPW occasion 1306. However, the network may not schedule any UL/DL transmissions during slots 26 to 30 as a result of the granted PPW.

The PPW occasion 1306 may be larger than the measurement gap occasion 1006 in FIG. 10, allowing for the UE to measure the set of PRSs 1301 during the PRS occasion 1302 and the entirety of the set of SSB 1303 during the SSB occasion 1304. The UE may be configured to request the PPW occasion 1306 if both the SSB measurement and the positioning measurement are critical for the UE, for example if both have a priority higher than a threshold (e.g., a handover and a 911-initiated positioning measurement occur at the same time). The UE may request for a PPW for a PFL that is not the same as the set of PRSs 1301, and may simply use the time period allocated for the PPW to measure the set of PRSs 1301. In other words, the UE may consider the PPW occasion 1306 as the same a measurement gap occasion, and may tune into any suitable frequency, such as the PFL that corresponds with the set of PRSs 1301. The UE may be pre-configured to prioritize PRS over the PPW, allowing the UE to ignore the PFL that the PPW is associated with. In some aspects, the UE may be configured to request a PPW of the size needed to decode the set of PRS 1301, for example the slots 26-29, extending the effective length of the measurement gap without needing to request all of the slots 21-30. In some aspects, the UE may be configured to both open its own measurement gap and request a PPW, which may reduce the PRS resource processing to have less of a n impact on serving cell channel performance loss.

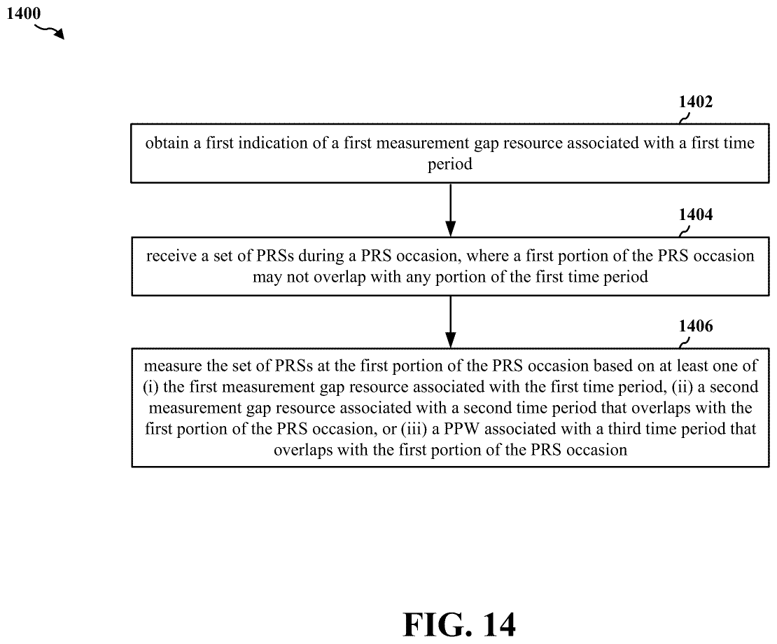

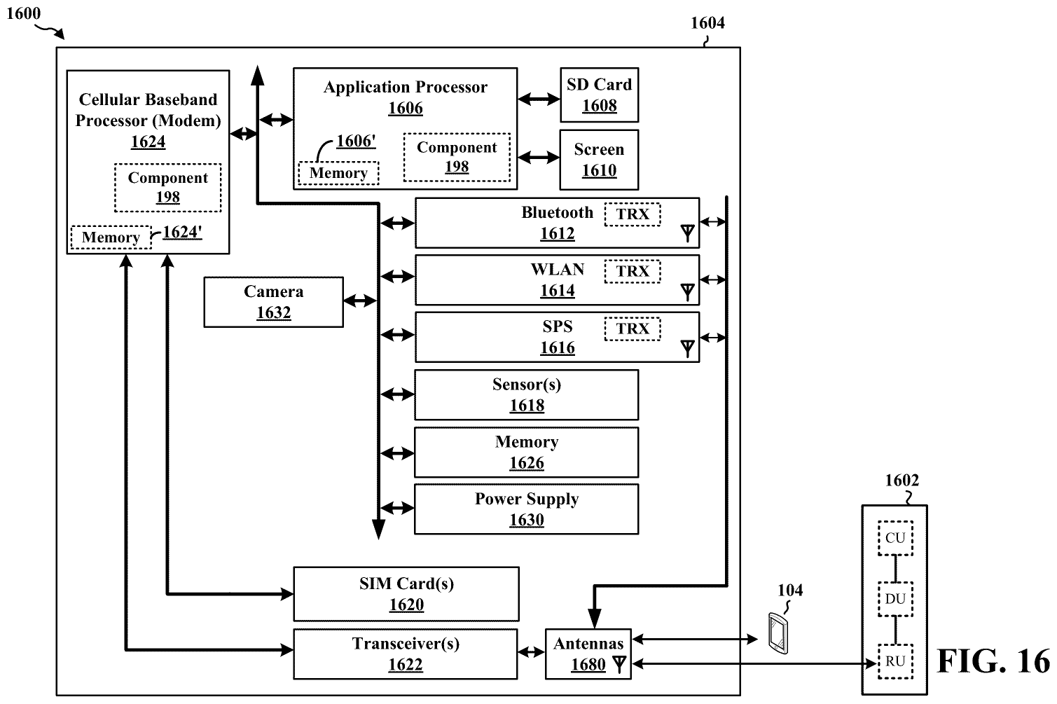

FIG. 14 is a flowchart 1400 of a method of wireless communication. The method may be performed by a UE (e.g., the UE 104, the UE 350, the UE apparatus 1604). At 1402, the UE may obtain a first indication of a first measurement gap resource associated with a first time period. 1402 may be performed by the component 198 in FIG. 16. A measurement gap resource may be a scheduled frequency band that the UE may use to measure a signal during a measurement gap, such as an SSB.

At 1404, the UE may receive a set of PRSs during a PRS occasion, where a first portion of the PRS occasion may not overlap with any portion of the first time period. 1404 may be performed by the component 198 in FIG. 16.

At 1406, the UE may measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion. 1406 may be performed by the component 198 in FIG. 16. A PPW may be a window that the UE requests from a network node serving the UE during which the UE may measure a signal, such as an SSB, a PDSCH, or a PDCCH. The PPW may allocate a resource and a period of time to the UE, during which the network node does not schedule any UL or DL transmissions with the UE, similar to a measurement gap occasion. During the PPW, the UE may choose whether to focus on any resources other than the resource associated with the PPW, allowing the UE to measure a PRS, even if the PRS may be transmitted using a resource other than the resource associated with the PPW.

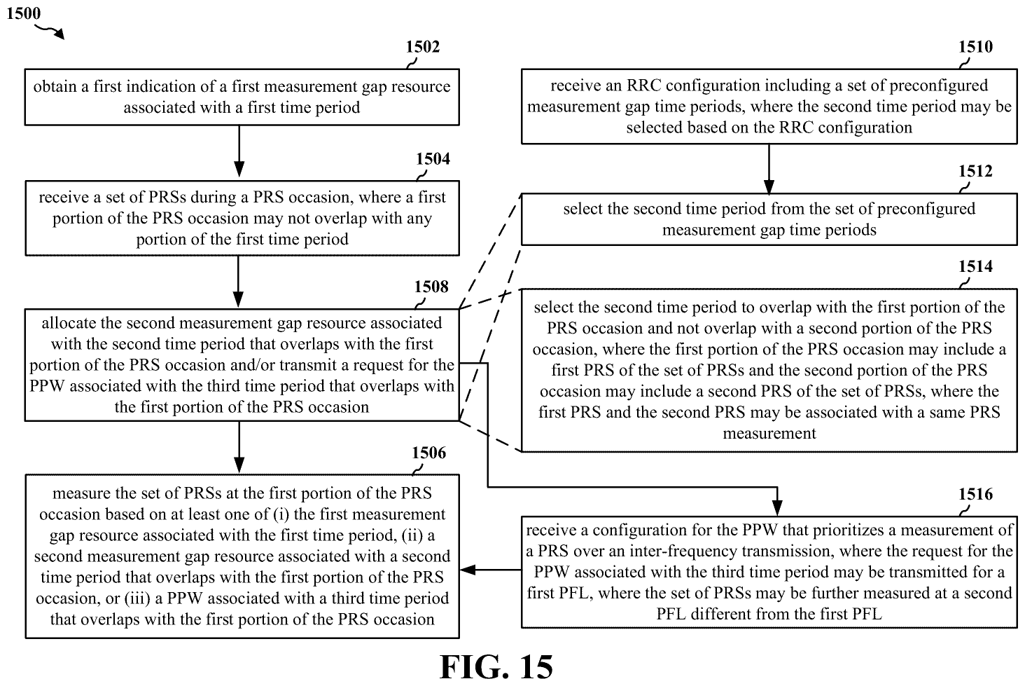

FIG. 15 is another flowchart 1500 of a method of wireless communication. The method may be performed by a UE (e.g., the UE 104, the UE 350, the UE apparatus 1604). At 1502, the UE may obtain a first indication of a first measurement gap resource associated with a first time period. 1502 may be performed by the component 198 in FIG. 16.

At 1504, the UE may receive a set of PRSs during a PRS occasion, where a first portion of the PRS occasion may not overlap with any portion of the first time period. 1504 may be performed by the component 198 in FIG. 16.

At 1506, the UE may measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion. 1506 may be performed by the component 198 in FIG. 16.

At 1508, the UE may allocate the second measurement gap resource associated with the second time period that overlaps with the first portion of the PRS occasion and/or transmit a request for the PPW associated with the third time period that overlaps with the first portion of the PRS occasion. 1508 may be performed by the component 198 in FIG. 16.

At 1510, the UE may receive an RRC configuration including a set of preconfigured measurement gap time periods, where the second time period may be selected based on the RRC configuration. 1510 may be performed by the component 198 in FIG. 16.

At 1512, the UE may select the second time period from the set of preconfigured measurement gap time periods. 1512 may be performed by the component 198 in FIG. 16.

At 1514, the UE may select the second time period to overlap with the first portion of the PRS occasion and not overlap with a second portion of the PRS occasion, where the first portion of the PRS occasion may include a first PRS of the set of PRSs and the second portion of the PRS occasion may include a second PRS of the set of PRSs, where the first PRS and the second PRS may be associated with a same PRS measurement. 1514 may be performed by the component 198 in FIG. 16.

At 1516, the UE may receive a configuration for the PPW that prioritizes a measurement of a PRS over an inter-frequency transmission, where the request for the PPW associated with the third time period may be transmitted for a first PFL, where the set of PRSs may be further measured at a second PFL different from the first PFL. 1516 may be performed by the component 198 in FIG. 16.

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include a cellular baseband processor 1624 (also referred to as a modem) coupled to one or more transceivers 1622 (e.g., cellular RF transceiver). The cellular baseband processor 1624 may include on-chip memory 1624′. In some aspects, the apparatus 1604 may further include one or more subscriber identity modules (SIM) cards 1620 and an application processor 1606 coupled to a secure digital (SD) card 1608 and a screen 1610. The application processor 1606 may include on-chip memory 1606′. In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The computer-readable medium/memory may also be used for storing data that is manipulated by the cellular baseband processor 1624/application processor 1606 when executing software. The cellular baseband processor 1624/application processor 1606 may be a component of the UE 350 and may include the memory 360 and/or at least one of the Tx processor 368, the Rx processor 356, and the controller/processor 359. In one configuration, the apparatus 1604 may be a processor chip (modem and/or application) and include just the cellular baseband processor 1624 and/or the application processor 1606, and in another configuration, the apparatus 1604 may be the entire UE (e.g., see 350 of FIG. 3) and include the additional modules of the apparatus 1604.

As discussed supra, the component 198 is configured to obtain a first indication of a first measurement gap resource associated with a first time period. The component 198 may be configured to receive a set PRSs during a PRS occasion. A first portion of the PRS occasion may not overlap with any portion of the first time period. The component 198 may be configured to measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1604 may include a variety of components configured for various functions. In one configuration, the apparatus 1604, and in particular the cellular baseband processor 1624 and/or the application processor 1606, may include means for obtaining a first indication of a first measurement gap resource associated with a first time period. The apparatus 1604 may include means for receiving a set PRSs during a PRS occasion. The apparatus 1604 may include means for measuring the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion. The apparatus 1604 may include means for allocating the second measurement gap resource associated with the second time period that overlaps with the first portion of the PRS occasion. The apparatus 1604 may include means for transmitting a request for the PPW associated with the third time period that overlaps with the first portion of the PRS occasion. The apparatus 1604 may include means for allocating the second measurement gap resource associated with the second time period may include selecting the second time period from a set of preconfigured measurement gap time periods. The apparatus 1604 may include means for allocating the second measurement gap resource associated with the second time period by selecting the second time period to overlap with the first portion of the PRS occasion and not overlap with a second portion of the PRS occasion. The apparatus 1604 may include means for receiving an RRC configuration including the set of preconfigured measurement gap time periods. The apparatus 1604 may include means for receiving a configuration for the PPW that prioritizes a measurement of a PRS over an inter-frequency transmission. The apparatus 1604 may include means for obtaining the first indication of the first measurement gap resource by receiving an RRC configuration that configures the first measurement gap resource. The apparatus 1604 may include means for measuring at least one RS using at least one of (i) the first measurement gap resource associated with the first time period, (ii) the second measurement gap resource associated with the second time period, or (iii) the PPW associated with the third time period. The apparatus 1604 may include means for measuring the at least one RS by measuring the at least one inter-frequency RS using the first measurement gap resource associated with the first time period. The apparatus 1604 may include means for measuring the at least one RS by measuring the at least one inter-frequency RS using at least one of (i) the first measurement gap resource associated with the first time period, (ii) the second measurement gap resource associated with the second time period, or (iii) the PPW associated with the third time period. The apparatus 1604 may include means for measuring the set of PRSs at the first portion of the PRS occasion by measuring an RSTD of at least one PRS of the set of PRSs. The apparatus 1604 may include means for receiving an SSB using at least one of the second measurement gap resource during the second time period or the PPW during the third time period. The apparatus 1604 may include means for decoding the SSB after receiving the SSB using at least one of the second measurement gap resource or the PPW. The means may be the component 198 of the apparatus 1604 configured to perform the functions recited by the means. As described supra, the apparatus 1604 may include the Tx processor 368, the Rx processor 356, and the controller/processor 359. As such, in one configuration, the means may be the Tx processor 368, the Rx processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data.

The following aspects are illustrative only and may be combined with other aspects or teachings described herein, without limitation.

Aspect 1 is a method of wireless communication at a UE, where the method may include obtaining a first indication of a first measurement gap resource associated with a first time period. The method may include receiving a set PRSs during a PRS occasion. A first portion of the PRS occasion may not overlap with any portion of the first time period. The method may include measuring the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a PPW associated with a third time period that overlaps with the first portion of the PRS occasion.

Aspect 2 is the method of aspect 1, where the method may include allocating the second measurement gap resource associated with the second time period that overlaps with the first portion of the PRS occasion. The method may include transmitting a request for the PPW associated with the third time period that overlaps with the first portion of the PRS occasion.

Aspect 3 is the method of aspect 2, where the second measurement gap resource associated with the second time period may be allocated in response to a data scheduling metric being less than or equal to a data scheduling threshold.

Aspect 4 is the method of any of aspects 2 to 3, where allocating the second measurement gap resource associated with the second time period may include selecting the second time period from a set of preconfigured measurement gap time periods.

Aspect 5 is the method of any of aspect 4, where the method may include receiving an RRC configuration including the set of preconfigured measurement gap time periods. The second time period may be selected based on the RRC configuration.

Aspect 6 is the method of any of aspects 4 to 5, where the second time period may be selected to overlap with a third portion of an SSB.

Aspect 7 is the method of any of aspects 2 to 6, where allocating the second measurement gap resource associated with the second time period may include selecting the second time period to overlap with the first portion of the PRS occasion and not overlap with a second portion of the PRS occasion. The first portion of the PRS occasion may include a first PRS of the set of PRSs and the second portion of the PRS occasion may include a second PRS of the set of PRSs. The first PRS and the second PRS may be associated with a same PRS measurement.

Aspect 8 is the method of any of aspects 2 to 7, where the request for the PPW associated with the third time period may be transmitted for a first PFL. The set of PRSs may be further measured at a second PFL different from the first PFL.

Aspect 9 is the method of aspect 8, where the method may include receiving a configuration for the PPW that prioritizes a measurement of a PRS over an inter-frequency transmission.

Aspect 10 is the method of any of aspects 1 to 9, where obtaining the first indication of the first measurement gap resource may include receiving an RRC configuration that configures the first measurement gap resource. The RRC configuration may be received from at least one of: a second UE, a network node, or a network entity.

Aspect 11 is the method of any of aspects 1 to 10, where the first time period may overlap with a collision range associated with the PRS occasion. The collision range may occur prior to the PRS occasion, after the PRS occasion, or both.

Aspect 12 is the method of any of aspects 1 to 11, where the first time period may include a set of slots or a set of subframes. The set of slots or the set of subframes may be associated with the first measurement gap resource.

Aspect 13 is the method of any of aspects 1 to 12, where the method may include measuring at least one RS using at least one of (i) the first measurement gap resource associated with the first time period, (ii) the second measurement gap resource associated with the second time period, or (iii) the PPW associated with the third time period.

Aspect 14 is the method of aspect 13, where the at least one RS may be at least one inter-frequency RS. Measuring the at least one RS may include measuring the at least one inter-frequency RS using the first measurement gap resource associated with the first time period.

Aspect 15 is the method of aspect 13, where the at least one RS may be at least one intra-frequency RS. Measuring the at least one RS may include measuring the at least one inter-frequency RS using at least one of (i) the first measurement gap resource associated with the first time period, (ii) the second measurement gap resource associated with the second time period, or (iii) the PPW associated with the third time period.

Aspect 16 is the method of any of aspects 1 to 15, where measuring the set of PRSs at the first portion of the PRS occasion may include measuring an RSTD of at least one PRS of the set of PRSs.

Aspect 17 is the method of any of aspects 1 to 16, where the first portion of the PRS occasion may include a first PRS of the set of PRSs and a second portion of the PRS occasion may include a second PRS of the set of PRSs. The first PRS and the second PRS may be associated with a same PRS measurement.

Aspect 18 is the method of aspect 17, where the set of PRSs may be measured at the first portion of the PRS occasion based on the first measurement gap resource. The set of PRSs may be measured in response to a resource repetition of the set of PRSs being greater than one.

Aspect 19 is the method of any of aspects 1 to 18, where the method may include receiving an SSB using at least one of the second measurement gap resource during the second time period or the PPW during the third time period.

Aspect 20 is the method of any of aspects 1 to 19, where the method may include decoding the SSB after receiving the SSB using at least one of the second measurement gap resource or the PPW.

Aspect 21 is an apparatus for wireless communication, including: a memory; and at least one processor coupled to the memory and, based at least in part on information stored in the memory, the at least one processor is configured to implement any of aspects 1 to 20.

Aspect 22 is the apparatus of aspect 21, further including at least one of an antenna or a transceiver coupled to the at least one processor.

Aspect 23 is an apparatus for wireless communication including means for implementing any of aspects 1 to 20.

Aspect 24 is a computer-readable medium (e.g., a non-transitory computer-readable medium) storing computer executable code, where the code when executed by a processor causes the processor to implement any of aspects 1 to 20.

What is claimed is:

1. An apparatus for wireless communication at a user equipment (UE), comprising:
a memory; and
at least one processor coupled to the memory and, based at least in part on information stored in the memory, the at least one processor is configured to:
obtain a first indication of a first measurement gap resource associated with a first time period;
receive a set of position reference signals (PRSs) during a PRS occasion, wherein a first portion of the PRS occasion does not overlap with any portion of the first time period; and
measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.

2. The apparatus of claim 1, wherein the at least one processor is further configured to:
allocate the second measurement gap resource associated with the second time period that overlaps with the first portion of the PRS occasion; or
transmit a request for the PPW associated with the third time period that overlaps with the first portion of the PRS occasion.

3. The apparatus of claim 2, wherein the second measurement gap resource associated with the second time period is allocated in response to a data scheduling metric being less than or equal to a data scheduling threshold.

4. The apparatus of claim 2, wherein, to allocate the second measurement gap resource associated with the second time period, the at least one processor is configured to:
select the second time period from a set of preconfigured measurement gap time periods.

5. The apparatus of claim 4, wherein the at least one processor is further configured to:
receive a radio resource control (RRC) configuration comprising the set of preconfigured measurement gap time periods, wherein the second time period is selected based on the RRC configuration.

6. The apparatus of claim 4, wherein the second time period is selected to overlap with a third portion of a synchronization signal block (SSB).

7. The apparatus of claim 2, wherein, to allocate the second measurement gap resource associated with the second time period, the at least one processor is configured to:
select the second time period to overlap with the first portion of the PRS occasion and not overlap with a second portion of the PRS occasion, wherein the first portion of the PRS occasion comprises a first PRS of the set of PRSs and the second portion of the PRS occasion comprises a second PRS of the set of PRSs, wherein the first PRS and the second PRS are associated with a same PRS measurement.

8. The apparatus of claim 2, wherein the request for the PPW associated with the third time period is transmitted for a first positioning frequency layer (PFL), wherein the set of PRSs is further measured at a second PFL different from the first PFL.

9. The apparatus of claim 8, wherein the at least one processor is further configured to:
receive a configuration for the PPW that prioritizes a measurement of a PRS over an inter-frequency transmission.

10. The apparatus of claim 1, further comprising a transceiver coupled to the at least one processor, where, to obtain the first indication of the first measurement gap resource, the at least one processor is configured to:
receive, via the transceiver, a radio resource control (RRC) configuration that configures the first measurement gap resource, wherein the RRC configuration is received from at least one of: a second UE, a network node, or a network entity.

11. The apparatus of claim 1, wherein the first time period overlaps with a collision range associated with the PRS occasion, wherein the collision range occurs prior to the PRS occasion, after the PRS occasion, or both.

12. The apparatus of claim 1, wherein the first time period comprises a set of slots or a set of subframes, wherein the set of slots or the set of subframes are associated with the first measurement gap resource.

13. The apparatus of claim 1, wherein the at least one processor is further configured to:
measure at least one reference signal (RS) using at least one of (i) the first measurement gap resource associated with the first time period, (ii) the second measurement gap resource associated with the second time period, or (iii) the PPW associated with the third time period.

14. The apparatus of claim 13, wherein the at least one RS is at least one inter-frequency RS, such that measuring the at least one RS comprises measuring the at least one inter-frequency RS using the first measurement gap resource associated with the first time period.

15. The apparatus of claim 13, wherein the at least one RS is at least one intra-frequency RS, such that measuring the at least one RS comprises measuring the at least one intra-frequency RS using at least one of (i) the first measurement gap resource associated with the first time period, (ii) the second measurement gap resource associated with the second time period, or (iii) the PPW associated with the third time period.

16. The apparatus of claim 1, wherein measuring the set of PRSs at the first portion of the PRS occasion comprises measuring a reference signal time difference (RSTD) of at least one PRS of the set of PRSs.

17. The apparatus of claim 1, wherein the first portion of the PRS occasion comprises a first PRS of the set of PRSs and a second portion of the PRS occasion comprises a second PRS of the set of PRSs, wherein the first PRS and the second PRS are associated with a same PRS measurement.

18. The apparatus of claim 17, wherein the set of PRSs is measured at the first portion of the PRS occasion based on the first measurement gap resource, wherein the set of PRSs is measured in response to a resource repetition of the set of PRSs being greater than one.

19. The apparatus of claim 1, wherein the at least one processor is further configured to:
receive a synchronization signal block (SSB) using at least one of the second measurement gap resource during the second time period or the PPW during the third time period.

20. The apparatus of claim 19, wherein the at least one processor is further configured to:
decode the SSB after receiving the SSB using at least one of the second measurement gap resource or the PPW.

21. A method of wireless communication at a user equipment (UE), comprising:
obtaining a first indication of a first measurement gap resource associated with a first time period;
receiving a set of position reference signals (PRSs) during a PRS occasion, wherein a first portion of the PRS occasion does not overlap with any portion of the first time period; and
measuring the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.

22. The method of claim 21, further comprising:
allocating the second measurement gap resource associated with the second time period that overlaps with the first portion of the PRS occasion; or
transmitting a request for the PPW associated with the third time period that overlaps with the first portion of the PRS occasion.

23. The method of claim 22, wherein allocating the second measurement gap resource associated with the second time period comprises selecting the second time period from a set of preconfigured measurement gap time periods.

24. The method of claim 23, further comprising:
receiving a radio resource control (RRC) configuration comprising the set of preconfigured measurement gap time periods, the second time period is selected based on the RRC configuration.

25. The method of claim 23, wherein the second time period is selected to overlap with a third portion of a synchronization signal block (SSB).

26. The method of claim 22, wherein the request for the PPW associated with the third time period is transmitted for a first positioning frequency layer (PFL), wherein the set of PRSs is further measured at a second PFL different from the first PFL.

27. The method of claim 21, further comprising:
measuring at least one reference signal (RS) using at least one of (i) the first measurement gap resource associated with the first time period, (ii) the second measurement gap resource associated with the second time period, or (iii) the PPW associated with the third time period.

28. The method of claim 21, further comprising:
receiving a synchronization signal block (SSB) using at least one of the second measurement gap resource during the second time period or the PPW during the third time period; and
decoding the SSB after receiving the SSB using at least one of the second measurement gap resource or the PPW.

29. An apparatus for wireless communication at a user equipment (UE), comprising:
means for obtaining a first indication of a first measurement gap resource associated with a first time period;
means for receiving a set of position reference signals (PRSs) during a PRS occasion, wherein a first portion of the PRS occasion does not overlap with any portion of the first time period; and
means for measuring the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.

30. A computer-readable medium storing computer executable code at a user equipment (UE), the code when executed by a processor causes the processor to:
obtain a first indication of a first measurement gap resource associated with a first time period;
receive a set of position reference signals (PRSs) during a PRS occasion, wherein a first portion of the PRS occasion does not overlap with any portion of the first time period; and
measure the set of PRSs at the first portion of the PRS occasion based on at least one of (i) the first measurement gap resource associated with the first time period, (ii) a second measurement gap resource associated with a second time period that overlaps with the first portion of the PRS occasion, or (iii) a positioning processing window (PPW) associated with a third time period that overlaps with the first portion of the PRS occasion.
